(19) United States
(12) Patent Application Publication
(10) Pub. No.: US 2008/0280519 A1
(43) Pub. Date: Nov. 13, 2008

(54) TEXTILE PRODUCTS DYED BY MEANS OF CATIONIC DYES, AND PROCESS FOR THE MANUFACTURE THERE

(76) Inventor: Alfredo Martinez Rodriguez, Puebla (MX)

Correspondence Address: FITCH EVEN TABIN AND FLANNERY, 120 SOUTH LA SALLE STREET, SUITE 1600, CHICAGO, IL, 60603-3406, US

(21) Appl. No.: 12/118,266

(22) Filed: May 9, 2008

(30) Foreign Application Priority Data
May 9, 2007 (MX) MX/A/2007/0005607

(51) Int. Cl. D06P 3/00; D06P 3/85; B32B 9/04

(52) U.S. Cl. 442/153; 8/529; 8/543

(57) ABSTRACT

The present invention relates to a fabric made of cotton or cotton blends with synthetic fibers, suitable for the manufacture of colored jeans, such that the fiber(s) which form the fabric, the yarn from which the fabric is made, or the fabric itself, are dyed by means of a direct, cationic dye so to obtain a fabric with firm colors and which can be washed down. The corresponding dyeing process is also described.

### BACKGROUND OF THE INVENTION

1. Field of the Invention

In the textile industry, dyeing is one of the most important finishing processes. Dyes are colored organic substances which are used to dye other objects, are soluble in acid, neutral or basic media, and possess an unsaturated molecular structure; that is, they are electronically unstable so they react with the material to be dyed, becoming fixed in the latter.

2. Description of Related Art

The endurance or strength of a dye can vary when it is applied to different fibers. Even though the use of a given dye is properly determined, the strength thereof varies, depending on the dyeing process used. Thus, depending on the fiber to be dyed and the final use of the fabric or knitting, the suitable type of dye and the suitable dyeing process should be chosen in order to obtain the desired results. The present invention relates specifically to the dyeing of cotton and blends thereof (polyester, acrylics, Tencel® (a cellulose fabric that is obtained by an organic solvent spinning process)) in colors which are different from indigo, by means of a direct, cationic dye commonly used for paper dyeing, such that bright and clean dyes are obtained with a proper behavior to wash down, achieving the desired worn-out in fabrics used for the manufacture of so-called “jeans”. A process suitable for achieving this type of dyeing is also disclosed.

A dye known as indigo is generally used for the dyeing of the fiber or yarn used in the manufacture of fabrics for making jeans, or for the dyeing of a knitted fabric, thus obtaining satisfactory results both for the dyed fabric as well as a washed down fabric. The use of indigo is limited to blue jeans. Up to this date, and even though the existing demand so requires, it has not been possible to obtain a fabric suitable for the manufacture of colored jeans, which exhibits brightness and the proper color both before and after wash down. In the manufacture of jeans and denim garments, it is common to combine in the same garment both a washed down fabric and a non washed down fabric, thus making apparent the importance of the characteristics of the fabric both before and after the wash down.

Dyeing with sulphur-based dyes has been attempted; however, while certain washed down effects are achieved with this type of dye, the necessary brightness and the desired clean colors are not obtained in the final product.

There is a diversity of developments relating to the dyeing of cotton yarn or fabric, or blends of cotton with other types of fibers; the most common ones disclose the use of indigo on blends of the latter with other types of dyes, such as those disclosed in U.S. Pat. Nos. 3,457,002; 4,166,715; 4,536,907; and 5,295,998; as well as publications JP 02170861, EP 0 408 269 and US 20060059635, among others, which disclose various dyeing methods using indigo and blends of indigo with other types of dyes or reagents in order to achieve the desired fixation. Neither the type of dye nor the methods used are suitable for dyeing cotton or blends of cotton with other types of fibers, such that the achieved fabric has the suitable color, the brightness and the behavior to wash down both before and after the wash down, for the manufacture of colored jeans. Likewise, there are developments which point to the use of sulphur based dyes and blends of the latter with other types of dyes, as well as the dyeing method for achieving the suitable fabric for the manufacture of jeans; some of these developments are disclosed in U.S. Pat. Nos. 4,131,423 and 4,322,214, international publications WO 93/07221, WO 00/36211, WO 04/012406, and European Patent EP 0 741 168, among others. As already mentioned, the use of sulphur based dyes does not achieve neither the desired brightness nor the desired behavior to wash down.

EP 0 343 925, in the name of Mitsui Toatsu Chemicals, relates to obtaining a colored denim fabric by means of a dyeing bath containing a dye or a dye blend with an indigo, so to obtain in the final product a behavior similar to that of indigos, also exhibiting the discoloring effect similar to when indigo is bleached with a chlorine solution. With the use of the method disclosed in EP 0 342 925, it is not possible to obtain the full range of desired colors, since the dye is blended with indigo, in addition to the fact that the obtained colors are not entirely clean nor have the brightness achieved with the dyes and the process of the present invention.

Most of the dyes are organic compounds which can be positively charged (cations) or negatively charged (anions). Cationic dyes are joined to the fibers by means of forming salt bonds with the anionic groups or the acid groups of the fibers and posses a very high dyeing power. Generally, they are used to dye paper, synthetic fibers and even human hair, since a bright coloring and a deep dyeing are achieved. Direct, cationic dyes had never before been used to dye fabric, fibers or yarn for the manufacture of fabric, for the manufacture of colored jeans, since as a result of obtaining so deep colors, the fabric does not react properly to wash down. Thus, cationic dyes have been traditionally considered in industry as unsuitable for cotton fibers, yarn or fabrics, including those cases where cotton is blended with other fibers, particularly synthetic fibers. The present invention relates to the use of direct, cationic dyes to dye fabrics, fibers or yarn made of cotton or cotton blends with synthetic fibers, for the manufacture of fabric, by means of any known dyeing process, using a direct, cationic dye, so that, controlling process variables such as temperatures, pH, concentration and exposure time, fabric with clean colors and the desired brightness is achieved, which suitably reacts to wash down. A fabric of these characteristics has not been nor is currently available in the market.

Among the patents relating to the manufacture and use of cationic dyes, the most relevant patents as prior art for the present invention are U.S. Pat. No. 4,288,589, assigned to Ciba-Geigy Corporation, which discloses a greenish-yellow cationic dye, the process for making same and its use for dyeing synthetic textile materials. In addition, international publication WO 05/012437, assigned to the above-named corporation, relates to another type of cationic dyes with alkaline terminations and its use, mainly, to dye human hair; JP 09316785, in the name of Sumitomo Chemical Co., relates to a method of dyeing cellulose fiber by means of a cationic dye, to achieve a sufficiently deep and clear color; in order to achieve this purpose, cellulose is pre-treated with a sulphur containing compound. U.S. Pat. No. 5,766,269, assigned to Clariant, discloses a type of cationic dye obtained by means of cationization of a sulphur dye with a compound comprising at least an amino group of a basic nature; the dyes thus obtained are used to dye acrylic fibers, cellulosic fibers, wool, silk and, mainly, leather. None of the above-mentioned patents even contemplates the behavior of the fabric to wash down nor the suitable dyeing process to achieve a fabric having the suitable brightness, the clean nature and the behavior to wash down for the manufacture of colored jeans.

### SUMMARY OF THE INVENTION

The present invention also relates to a method for dyeing fibers, yarn or fabrics made of cotton or cotton blends with synthetic fibers, by means of a direct, cationic dye which does not derive from nor contains sulphur, so to obtain a final product with a bright and clean dyeing and which can be washed down in processes or process steps after the dyeing in order to achieve the worn-out effect sought for fabrics used in the manufacture of jeans. Also described is the product obtained by means of this method.

An object of the present invention is obtaining a suitable fabric for the manufacture of colored jeans with an unsurpassable brightness and a suitable behavior to wash down.

Another object of the present invention is obtaining the range of colors not previously obtained with the described characteristics of brightness and behavior to wash down.

A further object of the present invention is the use of direct, cationic dyes for obtaining a fabric with the described brightness, color and behavior to wash down.

An additional object of the present invention is to provide a suitable method for obtaining the described fabric.

### DETAILED DESCRIPTION OF THE PREFERRED EMBODIMENT

There are in the market a multiplicity of dyes suitable for being used for the dyeing of textile fibers, such as cotton fibers or fibers made of blends of cotton with other fibers. Among these there are indigos, sulphur based dyes, dyeing reagents, azo dyes, as well as derivatives and blends thereof.

Likewise, many types of dyeing processes are known. Thus, it is possible to dye fibers, dye yarn of dye fabrics by means of various methods, such as dyeing by depletion, dyeing by means of a gun, dyeing by means of a brush or dyeing by immersion, among others. The variables to be considered in the dyeing process, generally, are: temperature, pH, time, volume, concentration, mechanical effect and adjuvant agents.

Dyes can be classified in several manners, according to their application, according to their chemical nature, etc. In the market, direct dyes can be found, which, as their name indicates, can be directly applied to the material to be dyed without the need of any adjuvant agent, as well as indirect dyes, which require the aid of compounds called mordants in order to be fixed to the material to be dyed. On the other hand, there exists a range of anionic dyes and cationic dyes, depending on the ionic character of its reactive group or groups.

A direct cationic dye is one the reactive groups of which are positively charged ions and which is used directly in the dyeing bath without the need of any type or vehicle or pre-treatment for the fiber for the dye to be fixed to the fiber. A direct, cationic dye is attached to the fibers by means of forming salt bonds with the anionic or acid groups of the fibers and has a very high dyeing power.

The present invention describes the dyeing of fibers, yarn or fabrics made of cotton or blends of cotton with synthetic fibers, using a direct, cationic dye.

The material to be dyed, that is fiber, yarn or fabric, is passed through a bath to remove natural impurities attached to the fibers, consisting of a water solution containing a cationic moisturizing agent in a concentration of about 2-10 g/l, the temperature of the bath varying between about 40 and 90° C., and the immersion time between about 10 and 30 seconds; the material is squeezed so that it has an absorption capacity after being squeezed, or “pick up”, of between about 60 and 80% of its own weight. Subsequently, the material is rinsed with water at a temperature of between about 40 and 80° C., passed to second rinsing step at room temperature; once it is rinsed, the material is squeezed until it achieves an absorption capacity (pick up) of about 150 to 300% of its own weight.

Subsequently, the material is passed to the dyeing process, properly speaking. The dyeing bath is prepared mixing the direct, cationic dye with water at a temperature of between about 60 and about 95° C.; the pH of the bath should be kept between about 4 and 9; in order to keep the pH within the indicated range, it is possible to use a buffer solution. The concentration of the dye varies between about 0.05 and 500 g/l, depending on the intensity of the color hue desired in the final product.

This dyeing bath can be used in any known dyeing process, such as dyeing by depletion the yarn, fiber, fabric or garment, continuous dyeing of the fabric, dyeing the yarn in width and in cord, or any type of dyeing process by immersion.

In the latter case, the material to be dyed can be passed through more than a single immersion tank, depending on the desired fixation and color. The immersion time varies between about 10 and 30 seconds.

The dyed material is rinsed with water at room temperature in order to remove the dye not fixed to the fiber and then passed to a fixation bath containing an anionic fixation agent, such as an arylsulfonate, in a concentration of about 80 to 120 g/l, with a residence time of about 30 to 60 seconds. Finally, the material is rinsed again with water at room temperature, obtaining the material—either fiber, yarn or fabric-dyed with the desired color and brightness and ready for subsequent processing.

After the dyeing, in the case of fibers, they are used to manufacture yarn and subsequently fabric; in the case of yarn, fabric is made therewith, so that the final product is a fabric with the desired color and brightness and which, in addition, can be washed down.

By means of the described process fabric can be produced in an ample range of colors. It is possible to use bi-coloring or tri-coloring, that is, mixing different colors of the same type of direct, cationic dye in order to obtain the desired color.

Many methods for wash down of fabrics are known, such as stone-wash, enzymatic wash, washing with potassium permanganate, and sand-blasting (with a sand stream), among other, and which are not an object of the present invention; however, the fabric obtained by means of the described process suitably reacts to any known method of wash down such that, in combination with the non washed down fabric obtained by means of the process of the present invention, it is used for the manufacture of garments such as jeans, coats, shirts, household textiles and the like.

Even though the invention has been described in light of its preferred embodiments, the scope of same encompass any type of change or modification which is apparent to those skilled in the art.

1. A fabric for manufacture of colored jeans_made of cotton or a blend of cotton with synthetic fibers and dyed by means of a direct, cationic dye.

2. A material for manufacturing a fabric for colored jeans, which material is selected from a group consisting of a cotton fiber, a yarn made of cotton and a yarn made of a blend of cotton with synthetic fibers, and dyed by means of a direct, cationic dye.

3. An immersion process for dyeing a material selected from a group consisting of fiber, yarn and fabric, with a direct, cationic dye, comprising the steps:
removing natural impurities from the material in an immersion bath;
dyeing the material;
a first washing;
fixation; and
a second washing;
wherein for removing natural impurities from the material to be dyed the material is passed through a bath comprising water at a temperature of between about 40 and 90° C., and a cationic moisturizer in a concentration of about 2 through 10 g/l; and
wherein the immersion time of the material in the immersion bath is between about 10 and 30 seconds.

4. The process according to claim 3, comprising providing a dyeing bath containing a mixture of water at a temperature of between about 60 and 94° C., a direct, cationic dye in a concentration of between about 0.05 and 500 g/l, and a buffering solution, such that the pH of the bath is kept between about 4 and 9.

5. The process according to claim 4, wherein the material is passed at least twice through the dyeing bath.

6. The process according to claim 5, wherein the concentration of the direct, cationic dye in the dyeing bath is different each time the material is passed through the bath.

7. The process according to claim 6, wherein in order to fixate the dye in the material, after the dyeing thereof, the material is washed with water at room temperature and passed through a fixation bath containing water at room temperature and an anionic fixation agent in a concentration of about 80 to 120 g/l with fixation time of about 30 to 60 seconds.

8. The process according to claim 7, wherein the fixation agent is an arylsulfonate-based fixation agent.

9. A garment dyed with direct, cationic dyes by the process according to claim 3.

10. A fabric made of cotton or cotton blends with synthetic fibers, suitable for manufacture of colored jeans, which is dyed by means of a process according to claim 3.

11. A fiber or yarn made of cotton or cotton blends with synthetic fibers dyed by means of the process according to claim 3, wherein the fiber or yarn is useful for manufacture of fabrics for colored jeans.

12. A garment dyed with direct, cationic dyes by the process according to claim 8.

13. A fabric made of cotton or cotton blends with synthetic fibers, suitable for manufacture of colored jeans, which is dyed by means of a process according to claim 8.

14. A fiber or yarn made of cotton or cotton blends with synthetic fibers dyed by means of the process according to claim 8, wherein the fiber or yarn is useful for manufacture of fabrics for colored jeans.

15. A process for dyeing a material containing cotton or blends of cotton with synthetic fibers, comprising placing the material in a dyeing bath containing a mixture of water at a temperature of between about 60 and 94° C., at least one direct, cationic dye in concentration of between about 0.05 and 500 g/l, and a buffering solution, wherein the pH of the bath is kept between about 4 and 9.

16. The process for dyeing a material according to claim 15, wherein the material is selected from a group consisting of fiber, yarn and fabric containing cotton or blends of cotton with synthetic fibers, and the dyeing is provided by depletion of the material.

17. The process for dyeing a material according to claim 15, wherein the material is a fabric containing cotton or blends of cotton with synthetic fibers, and the dyeing is provided by a continuous dyeing process.

18. The process for dyeing a material according to claim 15, wherein the material is a cord of yarn made of cotton or cotton blends with synthetic fibers.

19. The process for dyeing a material according to claim 15, wherein the mixture in the dyeing bath comprises a combination of two or more direct cationic dyes.
